(19) United States
(12) Patent Application Publication
(10) Pub. No.: US 2013/0304660 A1
(43) Pub. Date: Nov. 14, 2013

(54) Apparatuses, Systems, and Methods for Evaluating Pharmacy Benefits Plan Features

(71) Applicant: Optum, Inc., Minnetonka, MN (US)

(72) Inventors: Daniel J. Bohmfalk, Newport Beach, CA (US); William J. Perry, Woodbury, MN (US); Patrick J. Stroh, Prior Lake, MN (US); Stephen N. Ulanoski, Chanhassen, MN (US)

(73) Assignee: OPTUM, INC., Minnetonka, MN (US)

(21) Appl. No.: 13/891,337

(22) Filed: May 10, 2013

Related U.S. Application Data
(60) Provisional application No. 61/645,507, filed on May 10, 2012.
(60) Provisional application No. 61/656,435, filed on Jun. 6, 2012.

(51) Int. Cl. G06Q 10/10

(52) U.S. Cl. CPC G06Q 10/1057
USPC 705/322

(57) ABSTRACT

Apparatuses, systems and methods for evaluating variable pharmacy benefits plan features and estimating the costs attributed to those features are disclosed. A proposed pharmacy benefits plan is determined in response to a plurality of user preferences. The proposed pharmacy benefits plan is compared to a current pharmacy benefits plan, where the cost of the proposed and current pharmacy benefits plans are calculated according to variables in the plan features, and the cost of the proposed pharmacy benefits plan is recalculated by varying variables in the plan features.

### CROSS-REFERENCE TO RELATED APPLICATIONS

This application claims the benefit of priority of U.S. Provisional Patent Application No. 61/645,507 to Daniel J. Bohmfalk entitled “Apparatuses, Systems, and Methods for Evaluating Pharmacy Benefits Plan Features” and filed on May 10, 2012, and claims the benefit of priority of U.S. Provisional Patent Application No. 61/656,435 to Daniel J. Bohmfalk entitled “Apparatuses, Systems, and Methods for Evaluating Pharmacy Benefits Plan Features” and filed on Jun. 6, 2012, both of which are hereby incorporated by reference in their entirety.

### BACKGROUND OF THE INVENTION

1. Field of the Invention

This invention relates to pharmacy benefits plans and more particularly relates to apparatuses, systems, and methods for evaluating variable pharmacy benefits plan features and estimating the costs attributed to those features.

2. Description of the Related Art

Various features of pharmacy benefits plans can be difficult to evaluate. First, different organizations may need a pharmacy benefits plan that can apply to their specific employees and constituents. These organizations include consulting companies, general employers, payers, unions, and others. The cost of a pharmacy benefits plan may vary depending on the size of a particular organization (including the number of employees) as well as the type of organization. Second, various pharmacy benefits plans include myriad features and options based on the preferences of a given organization. For example, organizations may differ regarding generic penetration, the use of specialty pharmacies, the scope of a pharmacy network, the coverage of formulary, the expanse of mail programs, and amount of member cost share.

### SUMMARY OF THE INVENTION

Systems, methods, and apparatuses are discussed regarding an interactive tool to help determine how various pharmacy benefits plan features can impact both costs and results for a particular organization. In one embodiment, the method includes receiving a current pharmacy benefits plan defining one or more variable current pharmacy benefits plan features, receiving a plurality of user preferences, determining a proposed pharmacy benefits plan in response to the plurality of user preferences, and comparing the proposed pharmacy and the current pharmacy benefits plan. In one embodiment, the proposed pharmacy benefits plan defines one or more variable proposed pharmacy benefits plan features. In one embodiment, the comparison includes calculating the cost of the current pharmacy benefits plan based on one or more of the variable current pharmacy benefits plan features, calculating the cost of the proposed pharmacy benefits plan based on one or more of the variable proposed pharmacy benefits plan features, and recalculating the cost of the proposed pharmacy benefits plan in response to varying the variable proposed pharmacy benefits plan features.

In one embodiment, receiving a plurality of user preferences includes receiving a plurality pharmacy benefits plan feature preferences, receiving feature relative importance information regarding one or more pharmacy benefits plan feature preferences, creating a first group of pharmacy benefits plan features and a second group of pharmacy benefits plan features based on the received feature relative importance information, and receiving plan relative importance information regarding the first and second group of pharmacy benefits plan features.

In one embodiment, calculating the cost of the current pharmacy benefits plan further includes itemizing the cost of each of the one or more of the variable current pharmacy benefits plan features and calculating the cost of the proposed pharmacy benefits plan further comprises itemizing the cost of each of the one or more of the variable current pharmacy benefits plan features. In one embodiment, the cost of the current pharmacy benefits plan and the cost of the proposed pharmacy benefits plan are total annual costs. In an alternative embodiment, the cost of the current pharmacy benefits plan and the cost of the proposed pharmacy benefits plan are per month per member costs.

Systems for evaluating a pharmacy benefits plan including pharmacy benefits plan features are disclosed. In one embodiment, the system includes a data storage device configured to store user preferences and a processor in data communication with the data storage device. The processor is suitably configured to receive a current pharmacy benefits plan defining one or more variable current pharmacy benefits plan features, receive a plurality of user preferences, determine a proposed pharmacy benefits plan in response to the plurality of user preferences, and compare the proposed pharmacy and the current pharmacy benefits plan.

In one embodiment, the proposed pharmacy benefits plan defines one or more variable proposed pharmacy benefits plan feature. In one embodiment, the comparison includes calculating the cost of the current pharmacy benefits plan based on one or more of the variable current pharmacy benefits plan features, calculating the cost of the proposed pharmacy benefits plan based on one or more of the variable proposed pharmacy benefits plan features, and recalculating the cost of the proposed pharmacy benefits plan in response to varying the variable proposed pharmacy benefits plan features.

The term “coupled” is defined as connected, although not necessarily directly, and not necessarily mechanically.

The terms “a” and “an” are defined as one or more unless this disclosure explicitly requires otherwise.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

The OptumRX Mark is a trademark of Optum, Inc. of Eden Prairie, Minn. and forms no part of the claimed invention.

The OptumInsight Mark is a trademark of Optum, Inc. of Eden Prairie, Minn. and forms no part of the claimed invention.

The OptumHealth Mark is a trademark of Optum, Inc. of Eden Prairie, Minn. and forms no part of the claimed invention.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a schematic block diagram illustrating one embodiment of a system for evaluating pharmacy benefits plan features;

FIG. 2 is a schematic block diagram illustrating one embodiment of a database system used for evaluating pharmacy benefits plan features;

FIG. 3 is a schematic block diagram illustrating one embodiment of a computer system that may be used in accordance with certain embodiments of the system for evaluating pharmacy benefits plan features;

FIG. 4 is a schematic logical diagram illustrating one embodiment of abstraction layers of operation in a system for evaluating pharmacy benefits plan features;

FIG. 5 is a schematic block diagram illustrating one embodiment of a method for evaluating pharmacy benefits plan features;

FIG. 6 is a schematic block diagram illustrating one embodiment of comparing two pharmacy plans;

FIGS. 7A-C are screenshot examples of receiving user preference information related to a pharmacy benefits plan;

FIG. 8A is a screenshot example of receiving a current pharmacy benefits plan;

FIG. 8B is a screenshot example of outputting a proposed pharmacy benefits plan; and

FIGS. 9A-B are screenshot examples of calculating the costs of two pharmacy plans.

FIG. 10A is a screenshot example of selecting health analytics features.

FIG. 10B is a screenshot example of selecting health management features.

FIG. 10C is a screenshot example of selecting health insurance features.

FIG. 11 is a screenshot example of displaying cost and/or savings associated with selected features of the plans.

### DETAILED DESCRIPTION

Various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

In the following description, numerous specific details are provided, such as examples of programming, software modules, user selections, network transactions, database queries, database structures, hardware modules, hardware circuits, hardware chips, etc., to provide a thorough understanding of the present embodiments. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

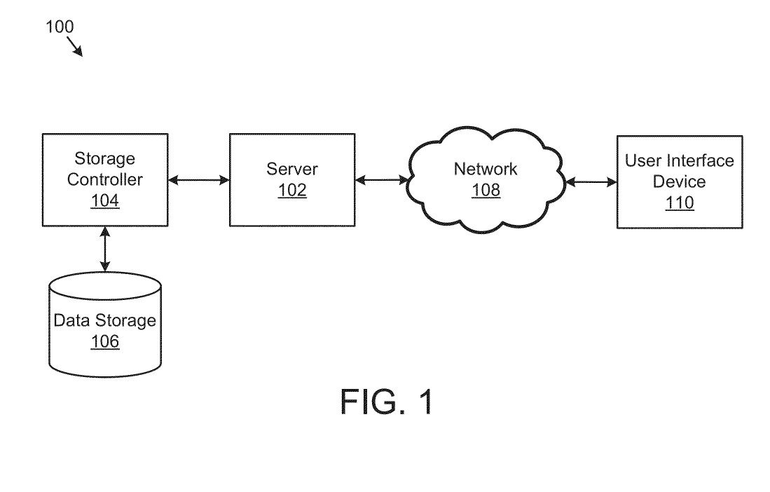

FIG. 1 illustrates one embodiment of a system 100 for evaluating pharmacy benefits plan features. The system 100 may include a server 102, a data storage device 106, a network 108, and a user interface device 110. In a further embodiment, the system 100 may include a storage controller 104, or storage server configured to manage data communications between the data storage device 106, and the server 102 or other components in communication with the network 108. In an alternative embodiment, the storage controller 104 may be coupled to the network 108. In a general embodiment, the system 100 may be used to evaluate the applicability of one or more plan features within a pharmacy benefits plan. Specifically, the system 100 may compare the features (and their associated costs) included in a current pharmacy benefits plan to features (and their associated costs) in a new (e.g., proposed) pharmacy benefits plan.

In one embodiment, the user interface device 110 is referred to broadly and is intended to encompass a suitable processor-based device such as a desktop computer, a laptop computer, a Personal Digital Assistant (PDA), a mobile communication device or organizer device having access to the network 108. In a further embodiment, the user interface device 110 may access the Internet to access a web application or web service hosted by the server 102 and provide a user interface for enabling a user to enter or receive information. For example, users may enter information related to their current pharmacy benefits plan as well as preferences regarding a new pharmacy benefits plan.

The network 108 may facilitate communications of data between the server 102 and the user interface device 110. The network 108 may include any type of communications network including, but not limited to, a direct PC to PC connection, a local area network (LAN), a wide area network (WAN), a modem to modem connection, the Internet, a combination of the above, or any other communications network now known or later developed within the networking arts which permits two or more computers to communicate, one with another.

In one embodiment, the server 102 is configured to receive a current pharmacy benefits plan; receive a plurality of user-preferences related to a new pharmacy benefits plan, determine a proposed pharmacy benefits plan based on the received user-preferences; and compare the current and proposed pharmacy benefits plan. Additionally, the server may access data stored in the data storage device 106 via a Storage Area Network (SAN) connection, a LAN, a data bus, or the like.

The data storage device 106 may include a hard disk, including hard disks arranged in an Redundant Array of Independent Disks (RAID) array, a tape storage drive comprising a magnetic tape data storage device, an optical storage device, solid state storage device, or the like. In one embodiment, the data storage device 106 may store health related data, such as insurance claims data, consumer data, or the like. The data may be arranged in a database and accessible through Structured Query Language (SQL) queries, or other data base query languages or operations.

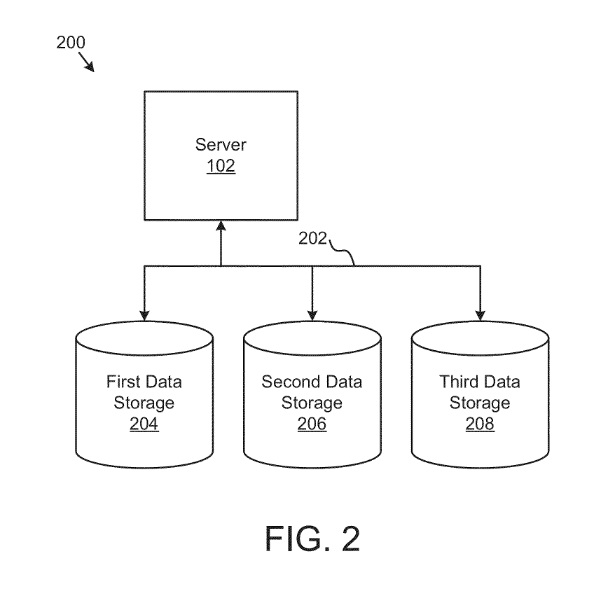

FIG. 2 illustrates one embodiment of a data management system 200 configured to store and manage data for evaluating pharmacy benefits plan features. In one embodiment, the system 200 may include a server 102. The server 102 may be coupled to a data-bus 202. In one embodiment, the system 200 may also include a first data storage device 204, a second data storage device 206 and/or a third data storage device 208. In further embodiments, the system 200 may include additional data storage devices (not shown). In such an embodiment, each data storage device 204-208 may host a separate database of related to the various features available within a pharmacy benefits plan, proposed pharmacy benefits plans, and the like.

In various embodiments, the server 102 may communicate with the data storage devices 204-208 over the data-bus 202. The data-bus 202 may comprise a SAN, a LAN, or the like. The communication infrastructure may include Ethernet, Fibre-Chanel Arbitrated Loop (FC-AL), Small Computer System Interface (SCSI), and/or other similar data communication schemes associated with data storage and communication. For example, there server 102 may communicate indirectly with the data storage devices 204-208; the server first communicating with a storage server or storage controller 104.

The server 102 may host a software application configured for evaluating pharmacy benefits plan features. The software application may further include modules for interfacing with the data storage devices 204-208, interfacing a network 108, interfacing with a user, and the like. In a further embodiment, the server 102 may host an engine, application plug-in, or application programming interface (API). In another embodiment, the server 102 may host a web service or web accessible software application.

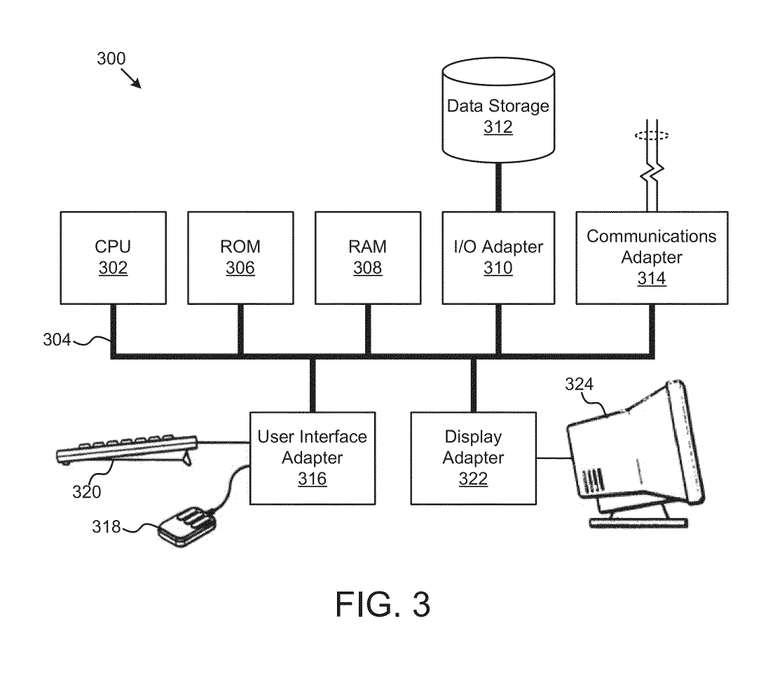

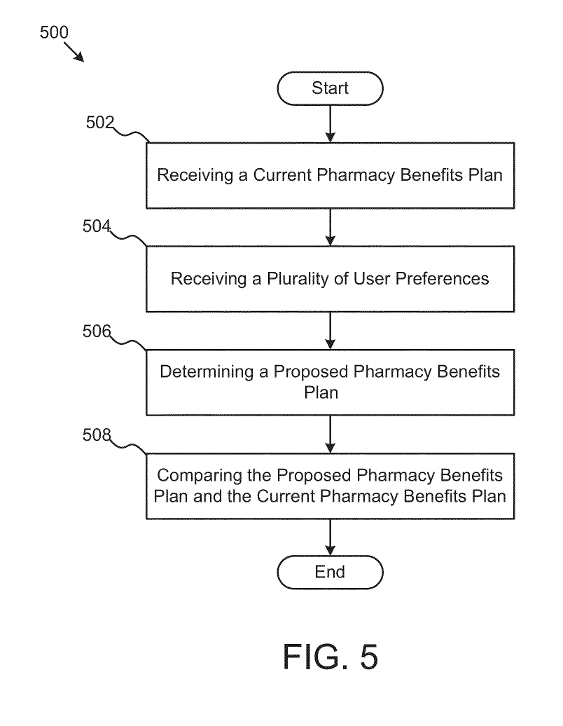

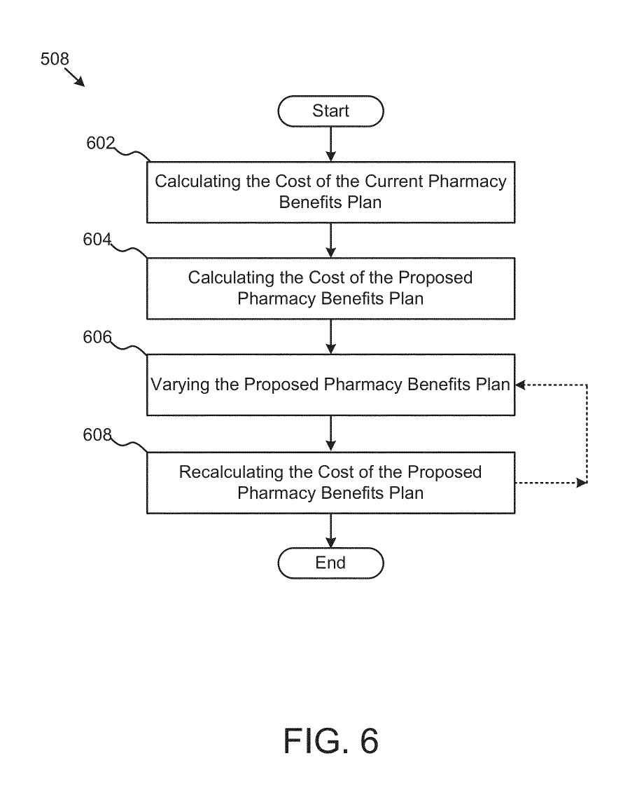

FIG. 3 illustrates a computer system 300 adapted according to certain embodiments of the server 102 and/or the user interface device 110. The central processing unit (CPU) 302 is coupled to the system bus 304. The CPU 302 may be a general purpose CPU or microprocessor. The present embodiments are not restricted by the architecture of the CPU 302, so long as the CPU 302 supports the modules and operations as described herein. The CPU 302 may execute the various logical instructions according to the present embodiments. For example, the CPU 302 may execute machine-level instructions according to the exemplary operations described below with reference to FIGS. 5 and 6.

The computer system 300 also may include Random Access Memory (RAM) 308, which may be SRAM, DRAM, SDRAM, or the like. The computer system 300 may utilize RAM 308 to store the various data structures used by a software application configured to evaluate pharmacy benefits plan features. The computer system 300 may also include Read Only Memory (ROM) 306 which may be PROM, EPROM, EEPROM, optical storage, or the like. The ROM may store configuration information for booting the computer system 300. The RAM 308 and the ROM 306 hold user and system 100 data.

The computer system 300 may also include an input/output (I/O) adapter 310, a communications adapter 314, a user interface adapter 316, and a display adapter 322. The I/O adapter 310 and/or user the interface adapter 316 may, in certain embodiments, enable a user to interact with the computer system 300 in order to input information for various user inputs described herein. In a further embodiment, the display adapter 322 may display a graphical user interface associated with a software or web-based application for evaluate pharmacy benefits plan features.

The I/O adapter 310 may connect to one or more storage devices 312, such as one or more of a hard drive, a Compact Disk (CD) drive, a floppy disk drive, a tape drive, to the computer system 300. The communications adapter 314 may be adapted to couple the computer system 300 to the network 108, which may be one or more of a LAN and/or WAN, and/or the Internet. The user interface adapter 316 couples user input devices, such as a keyboard 320 and a pointing device 318, to the computer system 300. The display adapter 322 may be driven by the CPU 302 to control the display on the display device 324.

The present embodiments are not limited to the architecture of system 300. Rather the computer system 300 is provided as an example of one type of computing device that may be adapted to perform the functions of a server 102 and/or the user interface device 110. For example, 96114155.1 any suitable processor-based device may be utilized including without limitation, including personal data assistants (PDAs), computer game consoles, and multi-processor servers. Moreover, the present embodiments may be implemented on application specific integrated circuits (ASIC) or very large scale integrated (VLSI) circuits. In fact, persons of ordinary skill in the art may utilize any number of suitable structures capable of executing logical operations according to the described embodiments.

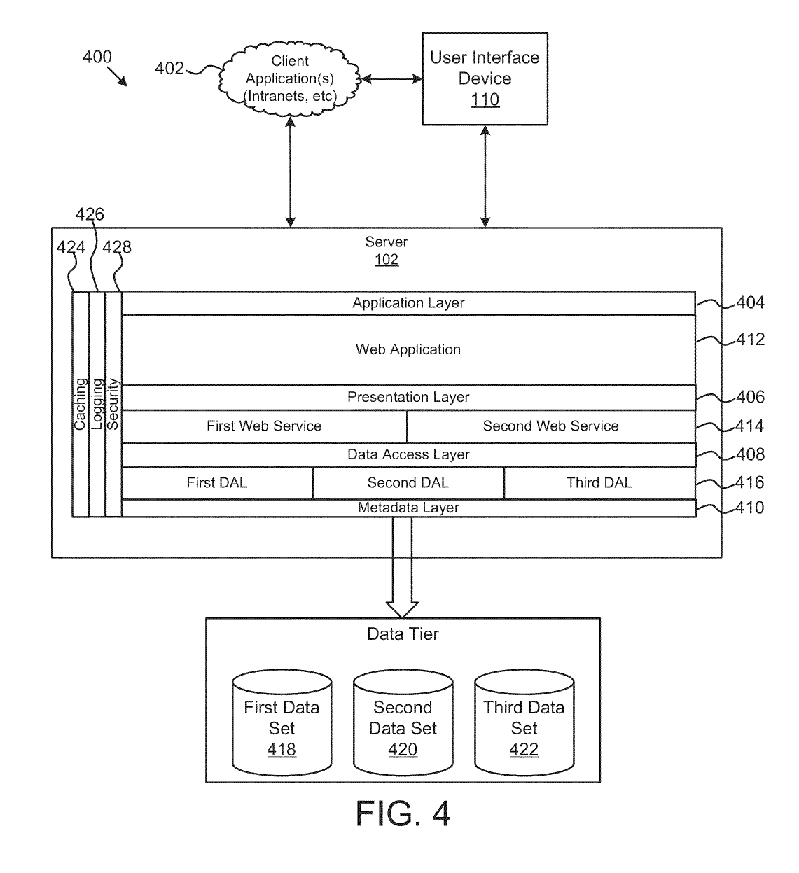

FIG. 4 illustrates one embodiment of a network-based system 400 for evaluating pharmacy benefits plan features. In one embodiment, the network-based system 400 includes a server 102. Additionally, the network-based system 400 may include a user interface device 110. In still a further embodiment, the network-based system 400 may include one or more network-based client applications 402 configured to be operated over a network 108 including an intranet, the Internet, or the like.

The network-based system 400 may include components or devices configured to operate in various network layers. For example, the server 102 may include modules configured to work within an application layer 404, a presentation layer 406, a data access layer 408 and a metadata layer 410. In a further embodiment, the server 102 may access one or more data sets 418-422 that comprise a data layer or data tier. For example, a first data set 418, a second data set 420 and a third data set 422 may comprise a data tier that is stored on one or more data storage devices 204-208.

One or more web applications 412 may operate in the application layer 404. For example, a user may interact with the web application 412 though one or more I/O interfaces 318, 320 configured to interface with the web application 412 through an I/O adapter 310 that operates on the application layer. In one particular embodiment, a web application 412 may be provided for evaluating pharmacy benefits plan features that includes software modules configured to receive a current pharmacy benefits plan; receive a plurality of user-preferences related to a new pharmacy benefits plan, determine a proposed pharmacy benefits plan based on the received user-preferences; and compare the current and proposed pharmacy benefits plan.

In a further embodiment, the server 102 may include components, devices, hardware modules, or software modules configured to operate in the presentation layer 406 to support one or more web services 414. For example, a web application 412 may access or provide access to a web service 414 to perform one or more web-based functions for the web application 412. In one embodiment, a web application 412 may operate on a first server 102 and access one or more web services 414 hosted on a second server (not shown) during operation.

For example, a web application 412 for evaluating pharmacy benefits plans may access a first web service 414 for receiving and analyzing user preferences and a second web service 414 for comparing one or more pharmacy benefits plans and their respective features. One of ordinary skill in the art will recognize various web-based architectures employing web services 414 for modular operation of a web application 412.

In one embodiment, a web application 412 or a web service 414 may access one or more of the data sets 418-422 through the data access layer 408. In certain embodiments, the data access layer 408 may be divided into one or more independent data access layers 416 for accessing individual data sets 418-422 in the data tier 412. These individual data access layers 416 may be referred to as data sockets or adapters. The data access layers 416 may utilize metadata from the metadata layer 410 to provide the web application 412 or the web service 414 with specific access to the data set 412.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

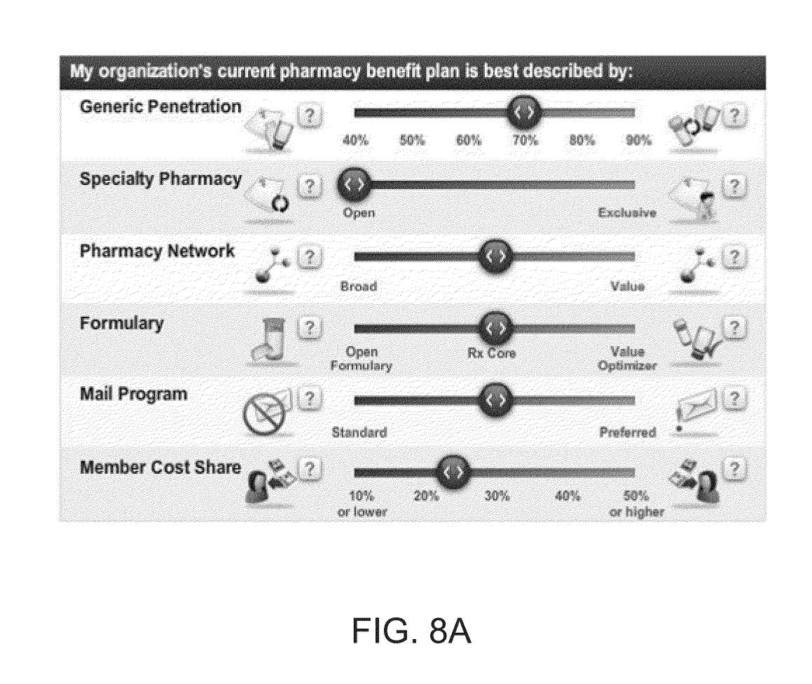

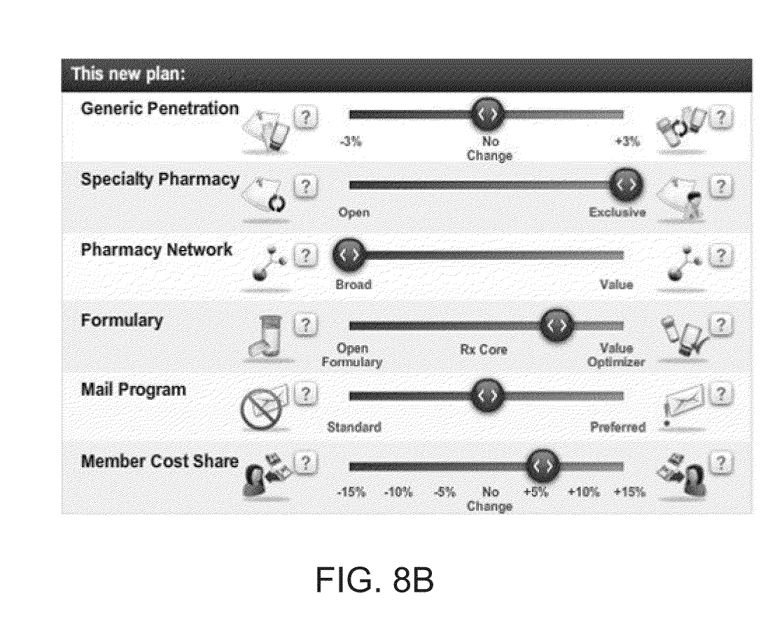

FIG. 5 illustrates one embodiment of a method 500 for evaluating pharmacy benefits plan features. In one embodiment, the method 500 starts by receiving 502 a current pharmacy benefits plan defining one or more variable current pharmacy benefits plan features. As shown with respect to FIG. 8A, for example, this current pharmacy benefits plan may be received through a user interface. These plan features may include (but are not limited to) generic penetration, specialty pharmacy, pharmacy network, formulary, mail program, and member cost share. Additionally, other features may include the number of covered members in the current pharmacy benefits plan (e.g., the approximate size of the organization covered by the plan). In some embodiments, the current pharmacy benefits plan may further be described by the current plan paid PMPM (e.g., per member per month) cost.

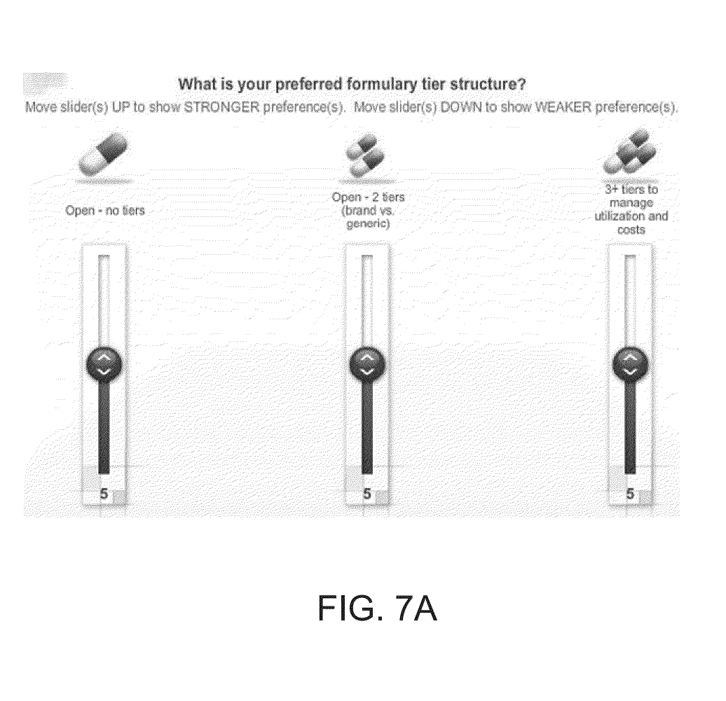

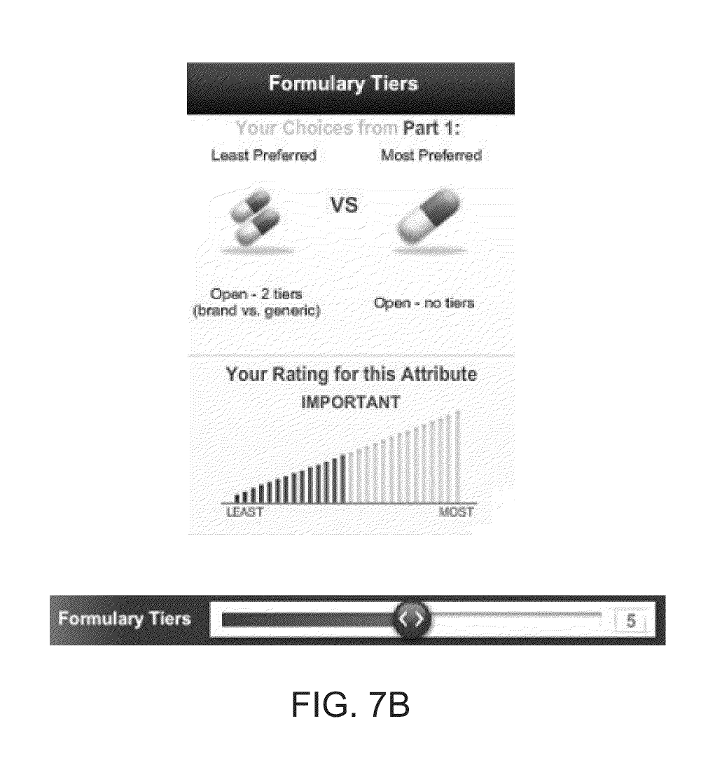

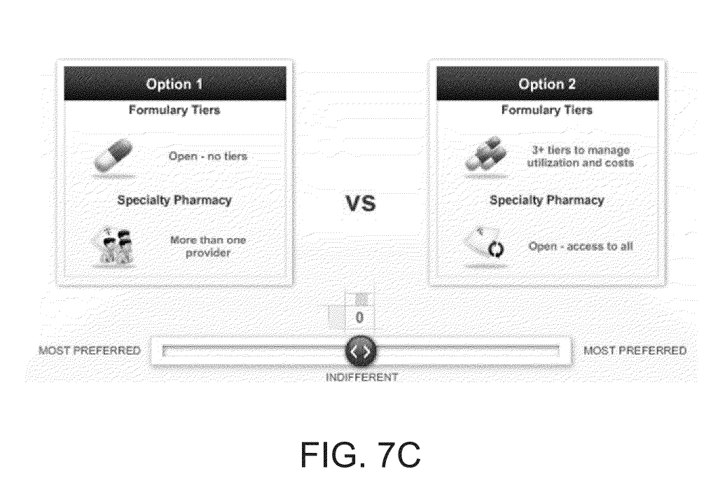

In some embodiments, the method 500 may further include receiving 504 a plurality of user preferences. In some embodiments, these user preferences help identify which user preferences may be more or less desirable to a given organization. FIG. 7 is a screenshot example of receiving user preference information related to a pharmacy benefits plan.

As shown in FIG. 7A, for example, a user input may be received describing the preferred formulary structure. For example, by moving the slider up on the first slider (i.e., the left most) and down on the third slider (i.e., the right most), a user can identify that a three-tiered formulary system is preferred less than an open formulary system. Similarly, by moving the slider down on both the first and third sliders, a user can identify that a two-tiered formulary system (e.g., with a brand name drugs and generic drugs) is a more preferred structure. As shown in FIG. 7, one method of receiving user inputs uses slider inputs, but the disclosed methods are not so limited. User inputs may be received using a variety of different techniques known in the art.

A variety of user preferences may be received regarding a pharmacy benefits plan. In some embodiments, receiving a plurality of user preferences may specifically include receiving a plurality of pharmacy benefits plan feature preferences. Several various pharmacy benefits plan feature preferences are discussed below in greater detail. As such, various embodiments of the disclosed methods, systems, and apparatuses may receive 504 some or all of these described user preferences. In some embodiments, user preferences may be received regarding overall objectives regarding a pharmacy benefits plan including preferences regarding lowering overall net drug cost, increasing compliance, growing utilization of cheaper drug delivery options, expanding drug copay tiers, implementing VBBD (value based benefit design), expanding disease management prevention & management programs, and/or shifting more cost/accountability to members. In some embodiments, user preferences may be received regarding formulary type including preferences regarding open formularies, the level of guidance on brand alternatives, and/or the level of guidance that limits choices for members but that is still clinically suitable. In some embodiments, user preferences may be received regarding brand rebate scenarios including preferences regarding maximizing brand rebates or alternatively to increasing the use of generics. In some embodiments, user preferences may be received regarding generics management including preferences regarding whether to dispense generics only as written, whether to apply switching edits to targeted meds or conditions, and/or whether to auto switch when equivalent drugs may exist. In some embodiments, user preferences may be received regarding integrated benefit plans including preferences regarding whether to have a single provider (e.g., for both pharmacy and medical plans), integrate providers, or separate providers. In some embodiments, user preferences may be received regarding copay approaches including preferences regarding whether member copays should be higher, lower, or the same as the current plan level. In some embodiments, user preferences may be received regarding network types including preferences regarding whether a broad, moderate, or narrow pharmacy network is preferred. In some embodiments, user preferences may be received regarding the preferred mail service approach including preferences regarding whether mail service should be accessible, offered, mandatory, and/or encouraged/incentivized with copy preferences. In some embodiments, user preferences may be received regarding specialty pharmacy program design including preferences regarding whether such access should be open to all, limited to a few providers, or limited to an exclusive provider. In some embodiments, user preferences may be received regarding clinical programs that may interest a user including geriatric prescription monitoring programs, narcotic drug utilization review program, polypharmacy programs, drug interaction alert programs, step therapy alert programs, quantity limits programs, and/or prior authorization programs. In some embodiments, user preferences may be received regarding utilization management/member controls including preferences regarding whether to have prior authorization from users, whether to have step therapy, whether to provide specialty medication services, whether to provide dosage optimization, whether to have over-the-counter strategies, whether to have quantity limits, and/d whether to encourage generic utilization. In some embodiments, user preferences may be received regarding member tools including preferences regarding preferred drug lists, prescription reordering, access to pharmacy directories, wellness portals, and branded websites (e.g., with FAQs). In some embodiments, user preferences may be received regarding account management features regarding whether the account representative (e.g., from the plan provider) is a pharmacist, access to service using phone/computer, visits from the account team (e.g., from the plan provider), and/or online account management tools.

In some embodiments, receiving a plurality of user preferences may further include receiving feature relative importance information regarding one or more pharmacy benefits plan feature preferences. For example, as shown with regard to FIG. 7B, specific pharmacy benefits plan feature preferences may be compared and feature relative importance information may be received. As shown in the figure, feature relative importance information may be received regarding the importance of having a two-tiered formulary versus having no tiers. In addition to formulary tiers, feature relative importance information may be received regarding features related to plan objectives, formulary type, brand rebates, generics management, integration, copay approach, network management, mail services, specialty pharmacy, member controls and/or member tools.

In some embodiments, receiving a plurality of user preferences may further include creating a first group of pharmacy benefits plan features and a second group of pharmacy benefits plans features based on the received feature relative importance information and subsequently receiving plan relative importance information regarding the first and second group of pharmacy benefits plan features. For example, as shown in FIG. 7C, a first group of pharmacy benefits plan features is shown on the left and a second group of pharmacy benefits plan features is shown on the right—each related to specific features regarding formulary tiers and specialty pharmacy. To help evaluate user preferences regarding the pharmacy benefits plan features, a group of pharmacy benefits plan features may be created using one or more of the received pharmacy benefits plan feature preferences. These features may be subsequently compared as shown with the slider shown in the figure or other like user input. In some embodiments, the steps of creating groups of pharmacy benefits plan features and receiving plan relative importance information may be repeated for various groups of pharmacy benefits plan features.

In some embodiments, the method 500 may include determining 506 a proposed pharmacy benefits plan. Such a proposed pharmacy benefits plan may include one or more variable proposed pharmacy benefits plan features. As shown in FIG. 8B for example, the proposed pharmacy benefits plan may include multiple features including generic penetration, specialty pharmacy, pharmacy network, formulary, mail program, and/or member cost share. In some embodiments, the proposed pharmacy benefits plan may be based on the received user preferences. For example, where the user preferences may indicate a preference toward an open formulary, the proposed plan would be more likely to propose an open formulary. As described the proposed pharmacy benefits plan includes proposed pharmacy benefits plan features. As shown with respect to the figure, in some embodiments these features may be displayed in a variable manner. As such, a user may be able to vary the proposed pharmacy benefits plan features using the user interface.

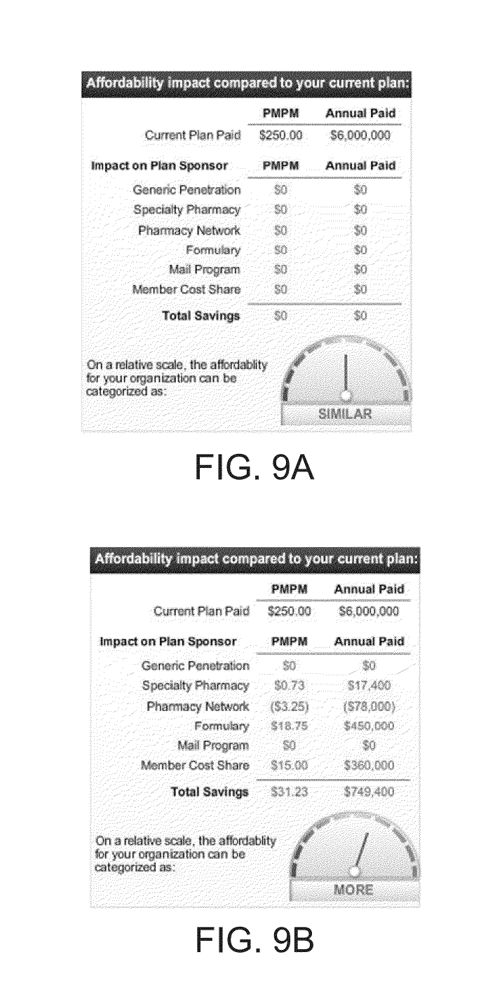

In some embodiments, the method 500 may include comparing 508 the proposed pharmacy and the current pharmacy benefits plan. The comparison 508 is described in more detail with respect to flowchart in FIG. 6. In some embodiments, the comparison 508 may include calculating 602 the cost of the current pharmacy benefits plan based on one or more of the variable current pharmacy benefits plan features, and the plan may further include calculating 604 the cost of the proposed pharmacy benefits plan based on one or more of the variable proposed pharmacy benefits plan features. In some embodiments, the calculation is performed both as a per member per month (PMPM) cost as well as a total annual cost for all members. As shown with respect to FIG. 9A, the “current plan paid” illustrates the PMPM of the current pharmacy benefits plan, and the “total savings” illustrates the calculated differences between the current pharmacy benefits plan and the proposed pharmacy benefits plan. In this example, the difference is illustrated, and in other embodiments, the value of the proposed pharmacy benefits plan cost may be shown. Also, in this particular example, the features of the current pharmacy benefits plan and the proposed pharmacy benefits plan are the same, and as such, the “total savings” is $0.

The comparison 508 may proceed by recalculating the cost of the proposed pharmacy benefits plan in response to varying the variable proposed pharmacy benefits plan features. The varying and recalculating steps are illustrated in blocks 606 and 608, respectively. As shown with respect to FIG. 9B, various proposed pharmacy features have varied, and the cost of the proposed pharmacy benefits plan has been recalculated. By changing specific features, users are able to visualize the cost effect of those features as they relate to the pharmacy benefits plan. Thus, in some embodiments, calculating the cost of the current pharmacy benefits plan further includes itemizing the cost of each of the one or more of the variable current pharmacy benefits plan features and calculating the cost of the proposed pharmacy benefits plan further comprises itemizing the cost of each of the one or more of the variable current pharmacy benefits plan features.

More particularly, though generic penetration and the mail program have remained the same, costs savings are available for features related to specialty pharmacy, formulary, and member cost share. At the same time, features related to the pharmacy network have become more expensive, but this particular user still has an overall cost savings. Based on budgets and user preferences, a user is able to vary the various plan features until a satisfactory plan is reached.

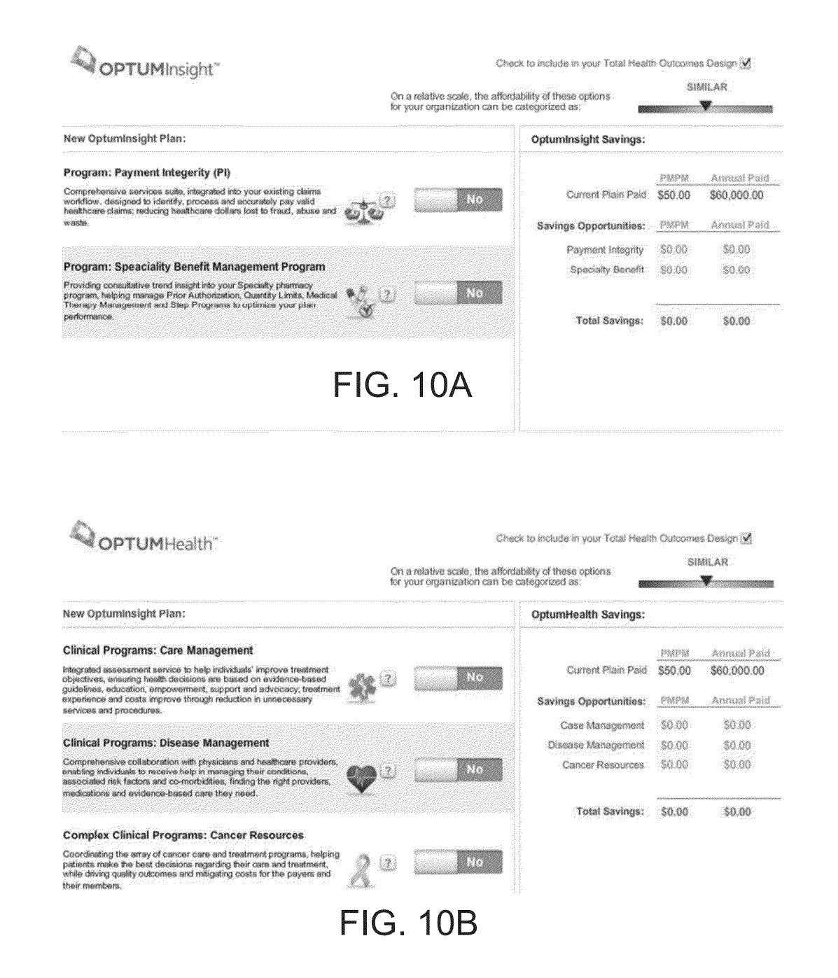

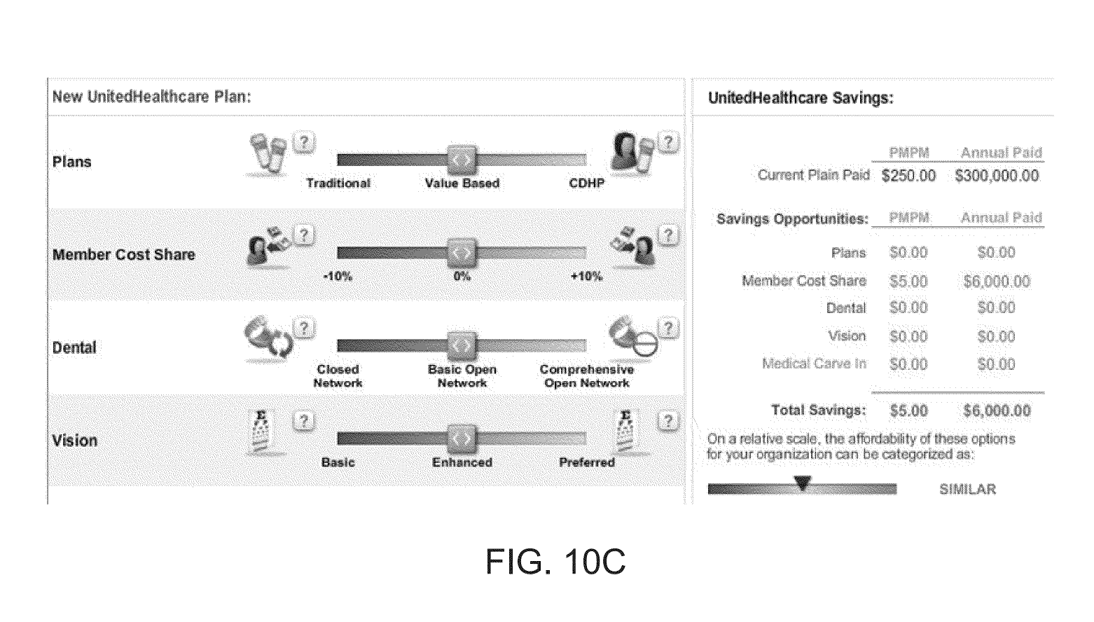

Other embodiments allow a user to evaluate a comprehensive health plan by selecting other benefits and services in addition to a pharmacy benefits plan, which may include health analytics services, health management services, and/or health insurance such as those shown in FIGS. 10A-C.

As shown in FIG. 10A, a user may be able to choose whether to receive one or more health analytics services, which may include features such as payment integrity services or specialty benefit management services. And as shown in FIG. 10B, a user may select one or more health management services, which may include features such as clinical care management programs, clinical disease management programs, or cancer management programs as shown in FIG. 10B.

In the embodiments illustrated in FIGS. 10A and 10B, the health analytics services and the health management services are shown as opt-in: the user chooses whether to receive one or more services by changing the toggle from “No” to “Yes.” In other embodiments, a range or tiered level of such services may be offered, and in these embodiments a slider may be used to receive the user preferences. In other embodiments, user inputs may be received using a variety of different techniques known in the art.

In still other embodiments, such as those shown in FIG. 10C, a user may select whether to enroll in one or more health insurance plans in addition to selecting a pharmacy benefits plan, and may further select the preferred features of the one or more health insurance plans. For example, a user may select a traditional health insurance plan, a value-based health insurance plan, or a consumer directed health insurance plan (DCHP). The user may also select a percent of the Member Cost Share, shown in this embodiment as a range between −10% (a decrease of 10% over current member cost share) and +10% (an increase of 10% over current member cost share).

In addition, a user may select whether to receive dental or vision coverage in some embodiments. For example, the user may select a closed network dental plan, a basic open network dental plan, or a comprehensive open network dental plan. Alternatively or in addition, the user may select a basic vision plan, an enhanced vision plan, or a preferred vision plan.

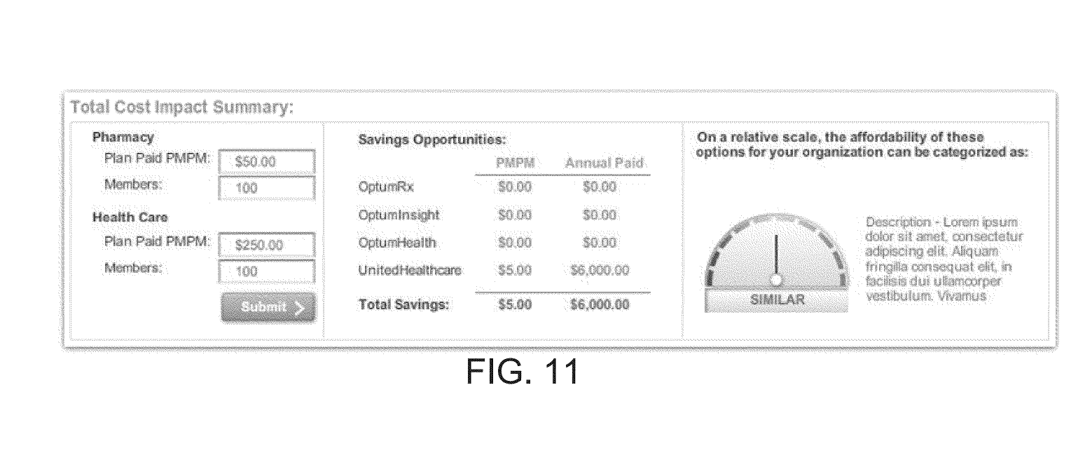

The various features of these services and plans may be varied and compared in a substantially similar manner as described above with respect to the pharmacy benefits plans in FIGS. 5 and 6. In various embodiments, such as those shown in FIG. 11, the costs and/or savings associated with selected features of the plans may be displayed to a user. In the embodiment shown, the OptumRx line shows the total savings on a PMPM and Amount Paid basis for pharmacy benefit plans. The OptumInsight line shows the total savings on a PMPM and Amount Paid basis for health analytics services. The OptumHealth line shows the total savings on a PMPM and Amount Paid basis for health management services. And the UnitedHealthcare line shows the total savings on a PMPM and Amount Paid basis for health insurance plans.

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention as defined by the appended claims.

What is claimed is:

1. A method for evaluating a pharmacy benefits plan comprising pharmacy benefits plan features, the method comprising:
receiving a current pharmacy benefits plan defining one or more variable current pharmacy benefits plan features;
receiving a plurality of user preferences;
determining a proposed pharmacy benefits plan in response to the plurality of user preferences, where the proposed pharmacy benefits plan defines one or more variable proposed pharmacy benefits plan features; and
comparing the proposed pharmacy and the current pharmacy benefits plan where the comparison comprises:
calculating the cost of the current pharmacy benefits plan based on one or more of the variable current pharmacy benefits plan features;
calculating the cost of the proposed pharmacy benefits plan based on one or more of the variable proposed pharmacy benefits plan features; and
recalculating the cost of the proposed pharmacy benefits plan in response to varying the variable proposed pharmacy benefits plan features.

2. The method of claim 1, where receiving a plurality of user preferences comprises:
receiving a plurality of pharmacy benefits plan feature preferences;
receiving feature relative importance information regarding one or more pharmacy benefits plan feature preferences;
creating a first group of pharmacy benefits plan features and a second group of pharmacy benefits plan features based on the received feature relative importance information;
receiving plan relative importance information regarding the first and second group of pharmacy benefits plan features.

3. The method of claim 1, where the cost of the current pharmacy benefits plan and the cost of the proposed pharmacy benefits plan are total annual costs.

4. The method of claim 1, where the cost of the current pharmacy benefits plan and the cost of the proposed pharmacy benefits plan are per month per member costs.

5. The method of claim 1, where calculating the cost of the current pharmacy benefits plan further comprises itemizing the cost of each of the one or more of the variable current pharmacy benefits plan features and calculating the cost of the proposed pharmacy benefits plan further comprises itemizing the cost of each of the one or more of the variable current pharmacy benefits plan features.

6. A system for evaluating a pharmacy benefits plan comprising pharmacy benefits plan features, the system comprising:
a data storage device configured to store user preferences;
a processor in data communication with the data storage device suitably configured to:
receive a current pharmacy benefits plan defining one or more variable current pharmacy benefits plan features;
receive a plurality of user preferences;
determine a proposed pharmacy benefits plan in response to the plurality of user preferences, where the proposed pharmacy benefits plan defines one or more variable proposed pharmacy benefits plan features; and
compare the proposed pharmacy and the current pharmacy benefits plan where the comparison comprises:
calculating the cost of the current pharmacy benefits plan based on one or more of the variable current pharmacy benefits plan features;
calculating the cost of the proposed pharmacy benefits plan based on one or more of the variable proposed pharmacy benefits plan features; and
recalculating the cost of the proposed pharmacy benefits plan in response to varying the variable proposed pharmacy benefits plan features.

7. The system of claim 6, where receiving a plurality of user preferences comprises:
receiving a plurality of pharmacy benefits plan feature preferences;
receiving feature relative importance information regarding one or more pharmacy benefits plan feature preferences;
creating a first group of pharmacy benefits plan features and a second group of pharmacy benefits plan features based on the received feature relative importance information;
receiving plan relative importance information regarding the first and second group of pharmacy benefits plan features.

8. The system of claim 6, where the cost of the current pharmacy benefits plan and the cost of the proposed pharmacy benefits plan are total annual costs.

9. The system of claim 6, where the cost of the current pharmacy benefits plan and the cost of the proposed pharmacy benefits plan are per month per member costs.

10. The system of claim 6, where calculating the cost of the current pharmacy benefits plan further comprises itemizing the cost of each of the one or more of the variable current pharmacy benefits plan features and calculating the cost of the proposed pharmacy benefits plan further comprises itemizing the cost of each of the one or more of the variable current pharmacy benefits plan features.

11. A tangible computer program product comprising a computer readable medium having computer usable program code executable to perform operations for evaluating a pharmacy benefits plan comprising pharmacy benefits plan features, the method comprising:
receiving a current pharmacy benefits plan defining one or more variable current pharmacy benefits plan features;
receiving a plurality of user preferences;
determining a proposed pharmacy benefits plan in response to the plurality of user preferences, where the proposed pharmacy benefits plan defines one or more variable proposed pharmacy benefits plan features; and
comparing the proposed pharmacy and the current pharmacy benefits plan where the comparison comprises:
calculating the cost of the current pharmacy benefits plan based on one or more of the variable current pharmacy benefits plan features;
calculating the cost of the proposed pharmacy benefits plan based on one or more of the variable proposed pharmacy benefits plan features; and
recalculating the cost of the proposed pharmacy benefits plan in response to varying the variable proposed pharmacy benefits plan features.

12. The computer program product of claim 11, where receiving a plurality of user preferences comprises:
receiving a plurality of pharmacy benefits plan feature preferences;
receiving feature relative importance information regarding one or more pharmacy benefits plan feature preferences;
creating a first group of pharmacy benefits plan features and a second group of pharmacy benefits plan features based on the received feature relative importance information;
receiving plan relative importance information regarding the first and second group of pharmacy benefits plan features.

13. The computer program product of claim 11, where the cost of the current pharmacy benefits plan and the cost of the proposed pharmacy benefits plan are total annual costs.

14. The computer program product of claim 11, where the cost of the current pharmacy benefits plan and the cost of the proposed pharmacy benefits plan are per month per member costs.

15. The computer program product of claim 11, where calculating the cost of the current pharmacy benefits plan further comprises itemizing the cost of each of the one or more of the variable current pharmacy benefits plan features and calculating the cost of the proposed pharmacy benefits plan further comprises itemizing the cost of each of the one or more of the variable current pharmacy benefits plan features.

16. A method for evaluating a comprehensive health plan comprising a pharmacy benefits plan comprising pharmacy benefits plan features; a health analytics service comprising health analytics features; a health management service comprising health management services features; and health insurance comprising health insurance features; the method comprising:
receiving a current pharmacy benefits plan defining one or more variable current pharmacy benefits plan features;
receiving a plurality of user preferences;
determining a proposed pharmacy benefits plan in response to the plurality of user preferences, where the proposed pharmacy benefits plan defines one or more variable proposed pharmacy benefits plan features; and
comparing the proposed pharmacy and the current pharmacy benefits plan where the comparison comprises:
calculating the cost of the current pharmacy benefits plan based on one or more of the variable current pharmacy benefits plan features;
calculating the cost of the proposed pharmacy benefits plan based on one or more of the variable proposed pharmacy benefits plan features; and
recalculating the cost of the proposed pharmacy benefits plan in response to varying the variable proposed pharmacy benefits plan features; and
receiving a selection of one or more health analytics features, health management services features, or health insurance features.

17. The method of claim 16, where health analytics features further comprise: a payment integrity plan and a specialty benefit management program plan.

18. The method of claim 16, where health management features further comprise: a care management program, a disease management program, and a

19. The method of claim 16, where health insurance features comprise further comprise: the type of plan, the member cost share, the type of dental plan, and the type of vision plan.
